(19) United States
(12) Patent Application Publication
(10) Pub. No.: US 2018/0254792 A1
(43) Pub. Date: Sep. 6, 2018

(54) WRAP FOR AN ELECTRONIC DEVICE

(71) Applicant: Richard Vincent Rueb, JR., Tulsa, OK (US)

(72) Inventor: Richard Vincent Rueb, JR., Tulsa, OK (US)

(21) Appl. No.: 15/909,633

(22) Filed: Mar. 1, 2018

Related U.S. Application Data
(60) Provisional application No. 62/466,964, filed on Mar. 3, 2017.

(51) Int. Cl. H04B 1/3888; A45C 11/00

(52) U.S. Cl. CPC H04B 1/3888; A45C 2011/002; A45C 11/00

(57) ABSTRACT

A wrap for a device with two opposing corners, the wrap comprising an elongate body and two securing elements capable of holding the two opposing corners of the device. The elongate body may be made of leather and may be generally rectangular. The securing elements may be parallel diagonal slits. Alternately, the securing elements may be corner holders. Each of the corner holders may attach to the body via an attachment device, which may removably attach to the corner holders with the body held therebetween and which may be interchangeable.

### CROSS REFERENCE

This application is based on and claims priority to U.S. Provisional Patent Application No. 62/466,964 filed Mar. 3, 2017.

### BACKGROUND OF THE INVENTION

### Field of the Invention

This invention relates generally to a wrap for an electronic device.

### Description of the Related Art

Users of electronic devices often attempt to protect their electronic devices, such as cell phones and tablets, with covers. Different covers offer different levels of protection, with the most basic merely protecting against scratches to the most complex attempting to offer a degree of shock absorption. Some covers offer additional features, such as straps or handles for more easily holding the device, pockets for identification or other cards, or decorative elements. All covers, however, share one characteristic: they obscure the inherent look and feel of the device. Most electronic devices are designed to have a pleasing appearance and hand feel. Covers, by their very nature, conceal this design and alter both the appearance and feel of the device.

Based on the foregoing, it is desirable to provide a minimalistic wrap for electronic devices, such as cell phones and tablets.

It is further desirable for the wrap to provide some degree of protection to the device.

It is further desirable for the wrap to minimally alter the look and feel of the device.

It is further desirable for the wrap itself to have an attractive design, both in look and feel.

It is further desirable for the wrap to allow the device to be used more easily.

### SUMMARY OF THE INVENTION

In general, in a first aspect, the invention relates to a wrap for a device with two opposing corners, the wrap comprising an elongate body and two securing elements capable of holding the two opposing corners of the device. The device may have two other corners, but the wrap may not be capable of holding the two other corners of the device. The elongate body may be made of leather and may be generally rectangular. The device may have a length and a width and where the elongate body has a length 2.33 to 2.5 or 3.33 to 3.5 times the length of the device and a width 1.5 to 1.67 times the width of the device.

The securing elements may be parallel diagonal slits. The parallel diagonal slits may be each oriented at a 45° angle.

Alternately, the securing elements may be corner holders. The corner holders may each be shaped like a right triangle with an open hypotenuse capable of receiving one of the corners of the device. Each of the corner holders may attach to the body via an attachment device. Each of the attachment devices may removably attach to the corner holders with the body held therebetween. The wrap may comprise a plurality of attachment devices, where the attachment devices are interchangeable. The attachment devices may be joined together and may form a handle. The attachment devices may be additionally decorative.

The wrap may further comprise one or more holes in the elongate body, where the one or more holes are suitable for hanging the wrap.

### BRIEF DESCRIPTION OF THE DRAWINGS

FIG. 1 is a perspective view of the wrap of the present invention;

FIG. 2 is a perspective view of the wrap in use with an electronic device, with the wrap in an open position;

FIG. 3 is a perspective view of the wrap in use with an electronic device, with the wrap in a closed position;

FIG. 4 is a perspective view of the wrap in use with an electronic device, with the wrap in a scrolled position;

FIG. 5 is a perspective view of the wrap with optional corner holders;

FIG. 6 is a perspective with of the wrap with optional corner holders in use with an electronic device, with the wrap in an open position;

FIG. 7 is a perspective back view of the wrap with optional corner holders;

FIG. 8 is a cross-sectional view of the wrap with optional corner holders;

FIG. 9 is a perspective view of a bi-fold version of the wrap in use with an electronic device, with the wrap in an open position; and

FIG. 10 is a perspective view of the bi-fold version of the wrap in use with an electronic device, with the wrap in a closed position.

Other advantages and features will be apparent from the following description and from the claims.

### DETAILED DESCRIPTION OF THE INVENTION

The devices and methods discussed herein are merely illustrative of specific manners in which to make and use this invention and are not to be interpreted as limiting in scope.

While the devices and methods have been described with a certain degree of particularity, it is to be noted that many modifications may be made in the details of the construction and the arrangement of the devices and components without departing from the spirit and scope of this disclosure. It is understood that the devices and methods are not limited to the embodiments set forth herein for purposes of exemplification.

In general, in a first aspect, the invention relates to a wrap 1 for an electronic device 2, such as a cell phone or tablet. While the wrap 1 is discussed herein as being used with an electronic device 2 and is illustrated with a cell phone or tablet, it may be used with any appropriately sized and shaped device or object 2, whether electronic or not, including but not limited to a book, notebook, calculator, laptop computer, or any other desired object. The wrap 1 may have any desired width, length, and spacing of securing elements 4, with all dimensions appropriate for the device 2 with which the wrap 1 is intended to be used. For example, dimensions are discussed herein for use with an iPad Pro 9.7 inch; these dimensions are not limiting, but are discussed for illustrative purposes.

The wrap 1 may be made of leather or any animal skin, including but not limited to ostrich or reptile skin; of any natural or synthetic fabric, including but not limited to polyurethane or rubber-based material; or of metal, including but not limited to precious metal, aluminum, or stainless steel. Alternately, the wrap 1 may be made of a flexible screen material and may be in communication with the device 2 such that the wrap 1 acts as an extension of the screen of the device 2. The wrap 1 may be elongate, and may be made of a single, generally rectangular piece of material. Alternately, the wrap 1 may be made of multiple pieces of material joined into a single unit. While the wrap 1 may be generally rectangular, it may have irregular edges and corners, as shown. Indeed, one of the short ends of the rectangle may be particularly angled, such that one of the long edges is longer than the other long edge, forming a point 3 at one end.

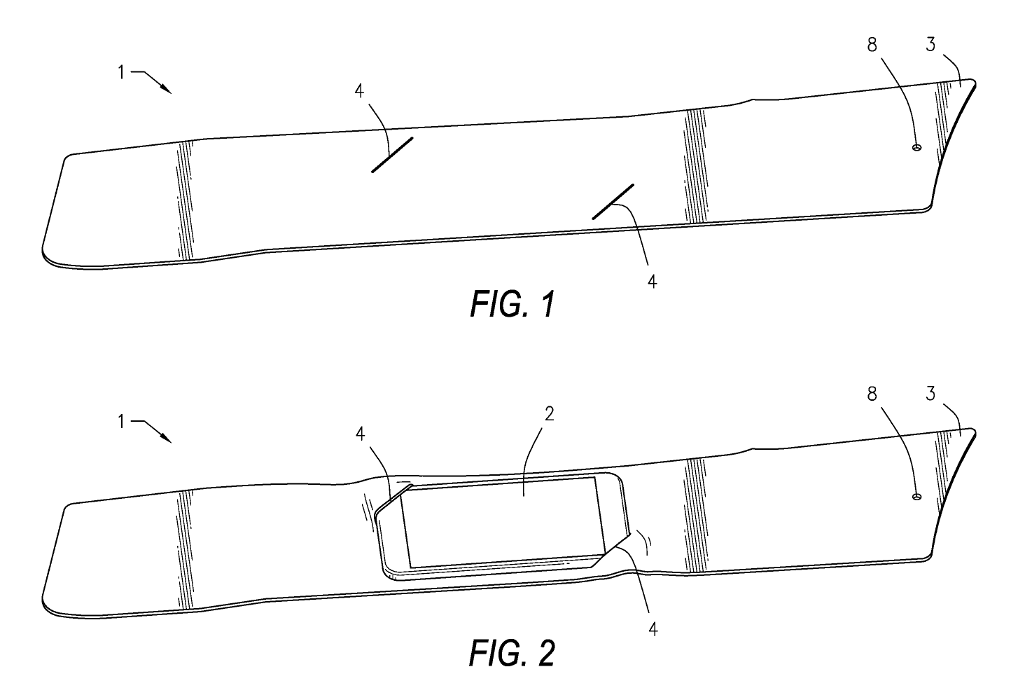

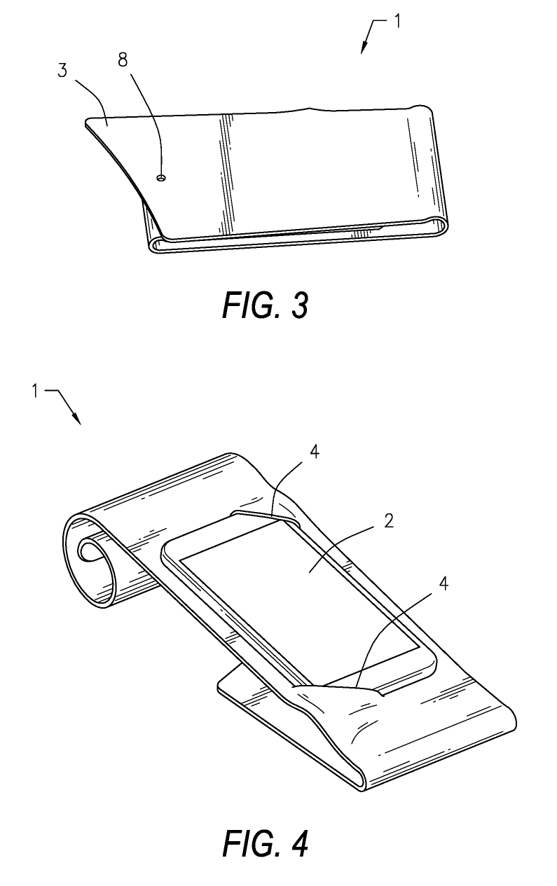

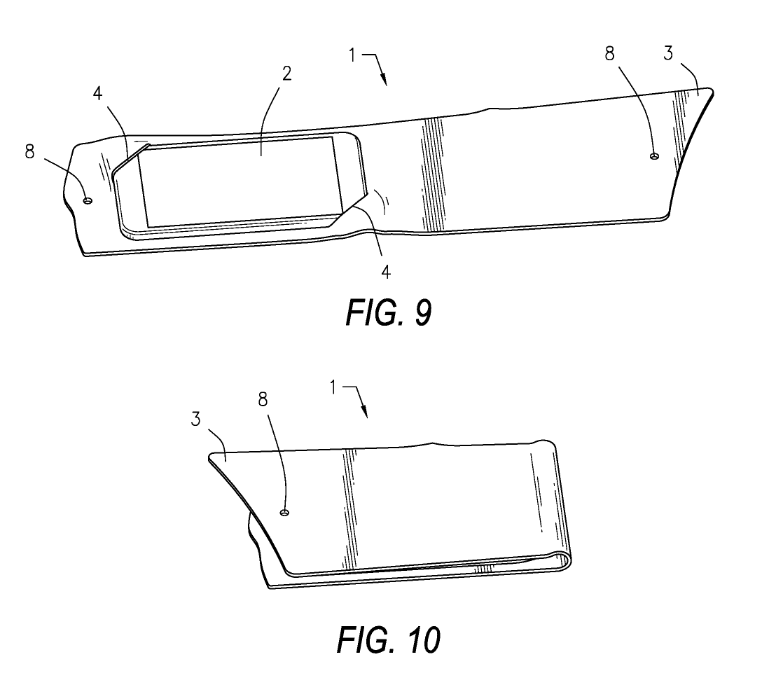

In particular, the wrap 1 may have a length approximately 3.33 to 3.1 times the length of the device 2 with which it is intended to be used and a width approximately 1.5 to 1.67 times the width of the device 2 with which it is intended to be used. For example, when the wrap 1 is intended for use with an iPad Pro 9.7 inch, the wrap 1 may have a width of approximately 10 inches and a length of approximately 32 inches. This length may allow the wrap 1 to be used in a tri-fold configuration, as shown in FIGS. 1 through 4. Alternately, the wrap 1 may have a length approximately 2.33 to 2.5 times the length of the device 2 with which it is intended to be used, allowing the wrap 1 to be used in a bi-fold configuration, as shown in FIGS. 9 and 10.

The wrap 1 may have two securing elements 4. These securing elements 4 may be located and spaced accordingly, depending on the size and shape of the device 2 with which the wrap 1 is intended to be used, that two opposing corners of the device 2 may be held by the securing elements 4. In particular, one securing element 4 may be located a distance from the bottom of the wrap 1 approximately equal to the length of the device 2 and close to one edge of the wrap 1, while the second securing element 4 may be located approximately the same distance from the opposite edge of the wrap 1 as the first securing element 4 is from the first edge of the wrap 1 and a distance from the first securing element 4 equal to the diagonal length of the device 2. For example, when the wrap 1 is intended for use with an iPad Pro 9.7 inch, one securing element 4 may be located approximately 9.5 inches from the bottom of the wrap 1 and approximately 1.5 inches from the side of the wrap 1, while the second securing element 4 may be located approximately 1.5 inches from the opposing side of the wrap 1 and 9.7 inches from the first securing element 4. Thus, two opposing corners of the iPad Pro 9.7 inch may be held by the two securing elements 4. The two securing elements 4 may hold the upper left and lower right corners of the device 2; alternately, the two securing elements 4 may hold the upper right and lower left corners of the device 2. Alternately the two securing elements 4 may be configured and located to hold other parts of the device 2.

The wrap 1 may only have two securing elements 4. In other words, the wrap 1 may hold two opposing corners of the device 2 via the securing elements 4, and may not hold any other part or parts of the device 2. In particular, the wrap 1 may not hold the other two corners of the device 2.

The securing elements 4 may be diagonal slits, as shown in FIGS. 1, 2, 4, and 9. The slits may be parallel to each other, each oriented at a 45° angle. Each slit may be an appropriate length to allow opposing corners of the device 2 to be inserted into the slits and to hold the device 2 securely, as shown in FIGS. 2, 4, and 9. For example, each slit may be 2 inches long.

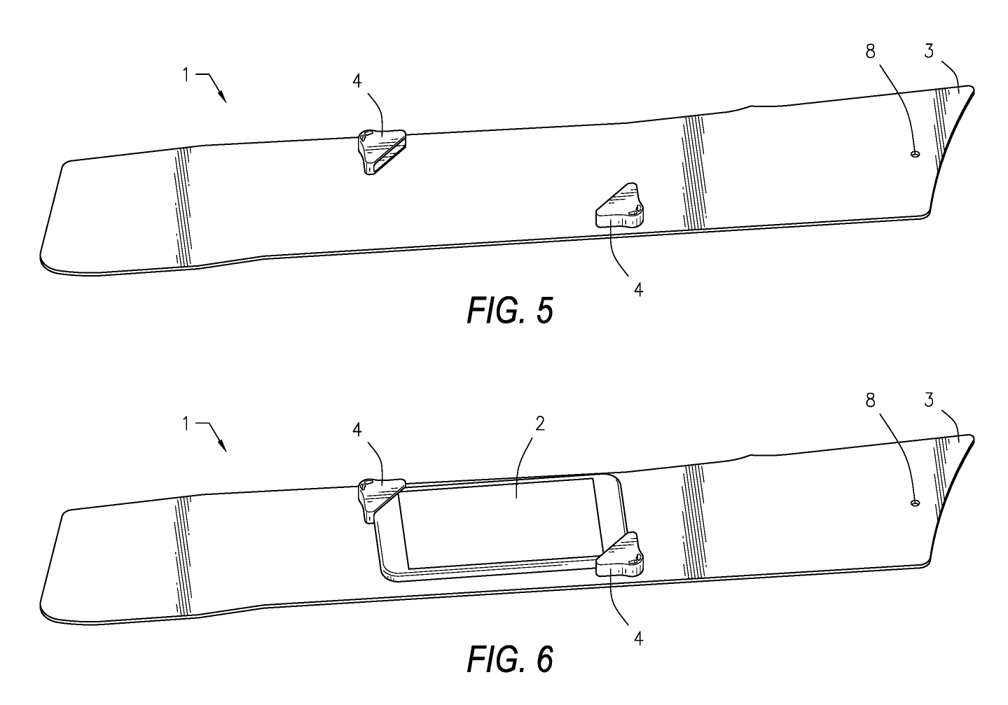

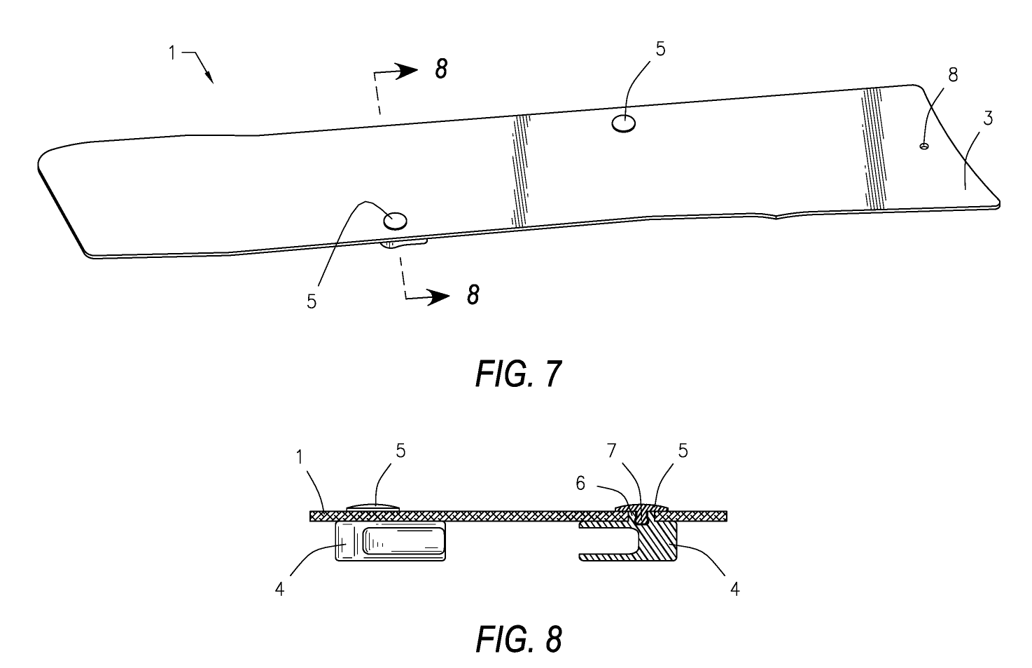

Alternately, the securing elements 4 may be corner holders, as shown in FIGS. 5 through 8. The corner holders may be sized, shaped, and positioned appropriately to allow opposing corners of the device 2 to be inserted into the corner holders and to hold the device 2 securely, as shown in FIG. 6. For example, the corner holders may be shaped like right triangles, with a top surface and a bottom surface, where the top and bottom surfaces are connected at least at the three corners of the triangle and the entire hypotenuse is open between the top and bottom surfaces, allowing a corner of the device 2 to be inserted into the corner holder through the hypotenuse. The other two sides of the corner holder may be open or closed, as desired. Likewise, the top and bottom surfaces may be solid, may have one or more holes or openings, or may have any other pattern or configuration, as desired.

When the securing elements 4 are corner holders, as discussed above and as shown in FIGS. 5 through 8, the corner holders may attach to the body of the wrap 1 via any desired fastening device or technique, including but not limited to rivets, screws, bolts, adhesive, hook and loop material, buttons, magnets, stitching, etc. In particular, each of the corner holders 4 may connect to an attachment device 5, with the body of the wrap 1 held between the corner holder 4 and the attachment device 5. The attachment device 5 may attach to the corner holder 4 via friction fit, such as by snapping into place. For example, the corner holder may have a projection 6 with a central opening, while the attachment device 5 may have a post 7 that snaps securely into the central opening of the projection 6 and is held therein via friction fit. The projection 6 may extend into a hole in the body of the wrap 1, with the attachment device 5 located on the opposing side of the wrap 1, thus holding the body of the wrap 1 between the corner holder and the attachment device 5, as shown in FIG. 8. Alternately, the post 7 may screw into the projection 6; the post 7 may have the central opening into which the projection may snap or screw; the corner holder may not have a projection 6, but may nonetheless have an opening into which the post 7 may snap or screw; the attachment device 5 may not have a post 7 but may nonetheless have an opening into which the projection 6 may snap or screw; or the corner holders 4 and attachment devices 5 may attach in a different way than via snapping or screwing, such as via magnets, buttons, hook and loop material, adhesive, or any other desired fastening device or technique.

The attachment devices 5 may be utilitarian, as shown, serving only to secure the securing elements 4 to the body of the wrap 1. Additionally or alternately, the attachment devices 5 may offer additional functionality. For example, the attachment devices 5 may project outwardly from the body of wrap 1, functioning as pegs between which a user may grip the device 2, reducing the likelihood of dropping the device, or which the user may utilize to hang the device 2 or otherwise secure the device 2 to another surface or object. As another example, the attachment devices 5 may be joined together, such as via a bar, handle, or chain. This may similarly allow the user to grip the device 2 more securely and reduce the likelihood of dropping the device 2. As another example, the attachment devices 5 may be magnets, allowing the device 2 to be attached to a ferromagnetic surface or to allow the attachment thereto of other elements that are made of or have elements of ferromagnetic material. Additionally or alternately, the attachment devices 5 may be decorative. For example, the attachment devices 5 may be any desired shape, may bear any desired design, and may be made of any desired material. The attachment devices 5 may be easily removed from the securing elements 4 and replaced with other attachment devices 5, allowing the attachment devices 5 to be used interchangeably as desired and the wrap 1 to be customized, possibly repeatedly, by the user.

The wrap 1 may optionally have one or more holes, slots, or connection points 8 for attaching accessories to the wrap 1 or for attaching the wrap 1 to other objects. For example, the wrap 1 may be hung on a hook or nail for use on a wall or other surface, or the wrap 1 may be hung from a necklace or lanyard, allowing the device 2 to be worn. In particular, the wrap 1 may have a ⅛ inch hole 8 located 1 inch from the bottom, centered side to side, to allow for hanging the wrap 1. As another example, the holes, slots, or connection points 8 may be used to secure the wrap 1 in a closed or folded position. For example, a leather nail, namely a short length of leather that is narrow in the middle and flares on both ends, or other closure device may be placed through holes 8 in the wrap 1 such that the leather nail or other closure device holds the wrap 1 closed. As another example, the wrap 1 may have long slots 8 in both ends, allowing the user to extend his or her hand through the slot 8 for carrying or wearing on the user's wrist. The wrap 1 may additionally or alternately have a strap.

The wrap 1 may additionally or alternately have one or more pockets and/or holders, such as for styluses, pencils, headphones, identification cards, credit cards, business cars, etc. Additionally or alternately, the wrap 1 may have laser etching, stitching, embossing, engraving, etc. as desired.

During use, the device 2 may be placed within the wrap by inserting opposing corners of the device 2 into the securing elements 4. The end or ends of the wrap 1, depending on whether the wrap 1 has a bi-fold or tri-fold configuration, may be folded over the surface of the device 2, protecting the device 2 from incidental damage when the device 2 is not in use. When the device 2 is in use, the user may hold the device by slipping his or her hand between the device 2 and the wrap 1, between the securing elements 4. This may allow the user to hold the device 2 comfortably and securely, reducing the likelihood of dropping the device 2. The user may allow the ends of the wrap 1 to hang, or may fold the ends out of the way as desired. When the user wishes to use, but not to hold, the device 2, the user may place the device 2 on a surface with the wrap 1 between the device 2 and the surface, protecting both the device 2 and the surface from incidental damage. The user may allow the ends of the wrap 1 to lie flat, or may fold the ends of the wrap 1 as desired. For example, as shown in FIG. 4, the user may roll one end of the wrap 1 into a scroll-like shape. This may elevate the end of the device 2, allowing for easier viewing and use. The opposing end may be folded out of the way, or may be extended outward to allow a surface upon which the user may rest his or her hand. If the user desires to hold the device 2 on the use's lap, the user may place the device on his or her leg with the ends of the wrap 1 dangling on either side of the user's leg. The wrap 1 may provide traction and the ends of the wrap 1 may act to weigh the device 2 down, aiding in preventing the device 2 from sliding off the user's lap. When the wrap 1 covers the screen of the device 2, the wrap 1 may shield the screen from view and offer the user privacy.

Whereas, the devices and methods have been described in relation to the drawings and claims, it should be understood that other and further modifications, apart from those shown or suggested herein, may be made within the spirit and scope of this invention.

What is claimed is:

1. A wrap for a device with two opposing corners, the wrap comprising:
an elongate body; and
two securing elements capable of holding the two opposing corners of the device.

2. The wrap of claim 1 where the device has two other corners and where the wrap is not capable of holding the two other corners of the device.

3. The wrap of claim 1 where the elongate body is made of leather.

4. The wrap of claim 1 where the elongate body is generally rectangular.

5. The wrap of claim 1 where the device has a length and a width and where the elongate body has a length 3.33 to 3.5 times the length of the device and a width 1.5 to 1.67 times the width of the device.

6. The wrap of claim 1 where the device has a length and a width and where the elongate body has a length 2.33 to 2.5 times the length of the device and a width 1.5 to 1.67 times the width of the device.

7. The wrap of claim 1 where the securing elements are parallel diagonal slits.

8. The wrap of claim 7 where the parallel diagonal slits are each oriented at a 45° angle.

9. The wrap of claim 1 where the securing elements are corner holders.

10. The wrap of claim 9 where the corner holders are each shaped like a right triangle with an open hypotenuse capable of receiving one of the corners of the device.

11. The wrap of claim 9 where each of the corner holders attach to the body via an attachment device.

12. The wrap of claim 11 where each of the attachment devices removably attach to the corner holders with the body held therebetween.

13. The wrap of claim 11 comprising a plurality of attachment devices, where the attachment devices are interchangeable.

14. The wrap of claim 11 where the attachment devices are joined together and form a handle.

15. The wrap of claim 11 where the attachment devices are additionally decorative.

16. The wrap of claim 1 further comprising one or more holes in the elongate body, where the one or more holes are suitable for hanging the wrap.
